(19) United States
(12) Patent Application Publication
(10) Pub. No.: US 2009/0131582 A1
(43) Pub. Date: May 21, 2009

(54) POLYMERIC MATERIALS

(75) Inventors: Simon Jonathon Grant, Lancashire (GB); John Russell Grasmeder, Cheshire (GB); Michael John Percy, Lancashire (GB); Brian Wilson, Lancashire (GB)

Correspondence Address: MICHAEL BEST & FRIEDRICH LLP, 100 E WISCONSIN AVENUE, Suite 3300, MILWAUKEE, WI, 53202, US

(73) Assignee: VICTREX MANUFACTURING LIMITED, Thornton Cleveleys, Lancashire (GB)

(21) Appl. No.: 12/304,864

(22) PCT Filed: Jun. 13, 2007
(86) PCT No.: PCT/GB07/02194

§ 371 Date: Feb. 4, 2009

(30) Foreign Application Priority Data
Jun. 14, 2006 (GB) 0611759.2

(51) Int. Cl. C08K 11/00; C08G 6/00

(52) U.S. Cl. 524/592; 528/226

(57) ABSTRACT

Polyaryletherketones and a method for producing the same are described wherein, for a given melt viscosity, the melt flow index is higher than expected. Such polymers may be used in situations where relative high flow is desirable.

This invention relates to polymeric materials and particularly, although not exclusively, relates to polymeric materials per se, processes for their preparation and uses of such materials. Preferred embodiments relate to polyaryletherketones, for example polyetheretherketone.

Polyetheretherketone is a high performance thermoplastic polymer which is used in situations where superior chemical and physical properties are required. The polymer is sold in grades having different melt viscosities and melt flow indexes and, therefore, different molecular weights.

In general terms, as the molecular weight of a polyetheretherketone increases there is a corresponding increase in melt viscosity and a corresponding decrease in the melt flow index. So, for polymers with the same molecular weight and melt viscosity, it should be possible to readily predict and/or calculate the melt flow index.

Low viscosity polymers have relatively high melt flow indexes which means they flow relatively easily. Such polymers can be used to produce highly filled composites (because the lower viscosity material is more able to flow around and/or wet a greater volume of filler material compared to higher viscosity polymers) and in injection moulding of parts having relatively thin walls (because the lower viscosity material is more able to flow into narrow parts of moulds). Disadvantageously, however, low viscosity low molecular weight/high melt flow index materials tend to have relatively poor physical properties, for example toughness, compared to higher molecular weight materials and, consequently, such low viscosity/low molecular weight polymers are not suitable for use in many situations.

It is an object of the present invention to produce polymers, for example polyaryletherketones such as polyetheretherketone or polyetherketone, which for a given melt viscosity have a higher melt flow index which may therefore allow such polymers to be used in situations where it is desired to use a relatively high molecular weight polymer which has acceptable flow characteristics.

According to a first aspect of the invention, there is provided a process for the preparation of a polymeric material which includes phenyl moieties, ketone moieties and ether moieties in the polymeric backbone of said polymeric material, said process comprising selecting at least one monomer having a moiety of formula

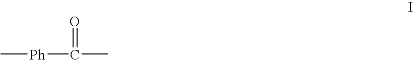

wherein Ph represents a phenyl moiety and wherein said at least one monomer has a purity of at least 99.7 area %.

Surprisingly, it has been found that by providing a relatively pure monomer of formula I, the Melt Flow Index (MFI) of said polymeric material prepared is significantly greater than expected. This finding may allow polymeric materials prepared to be more easily extruded, particularly at relatively high melt viscosity (MV); to be more highly filled than equivalent polymeric materials of the same MV; and to be more easily used to provide thin walled components compared to equivalent polymeric materials of the same MV, amongst other advantages.

Unless otherwise stated, Melt Viscosity/MV described herein is suitably measured using capillary rheometry operating at 400° C. at a shear rate of 1000 s⁻¹ using a tungsten carbide die, 0.5×3.175 mm, as described in the Test 1 hereinafter.

The purity of said at least one monomer may be assessed using Gas Chromotographic (GC) analysis, suitably using the method described in Test 3 hereinafter.

Said at least one monomer may have a purity of at least 99.75 area % suitably at least 99.8 area %, preferably at least 99.85 area %, more preferably at least 99.88 area %, especially at least 99.9 area %.

Said at least one monomer preferably includes at least two phenyl moieties which are suitably unsubstituted. Said at least two phenyl moieties are preferably spaced apart by another atom or group. Said other atom or group may be selected from —O— and —CO—. Said at least one monomer as described may comprise phenoxyphenoxybenzoic acid or a benzophenone.

Said at least one monomer preferably includes a terminal group selected from a halogen atom (for example a chlorine or fluorine atom, with the latter being especially preferred), an —OH moiety and a —COOH moiety. Said at least one monomer preferably includes a terminal group selected from a fluorine atom and a —COOH group.

Said process may comprise:
(a) polycondensing a compound of general formula

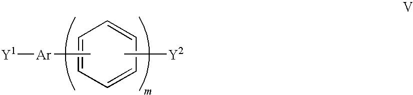

with itself wherein Y¹ represents a halogen atom or a group -EH and Y² represents a halogen atom or a group —COOH or EH, provided that Y¹ and Y² do not together represent hydrogen atoms;
(b) polycondensing a compound of general formula

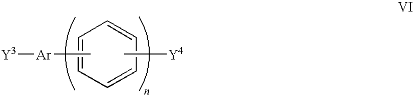

with a compound of formula

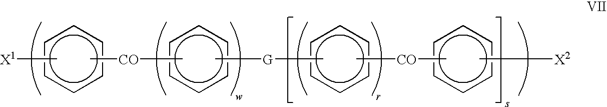

and/or with a compound of formula

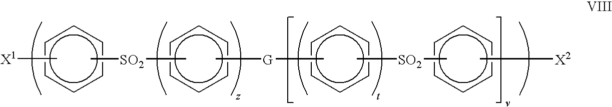

wherein Y³ represents a halogen atom or a group -EH and X¹ represents the other one of a halogen atom or group -EH and Y⁴ represents a halogen atom or a group -EH and X² represents the other one of a halogen atom or a group -EH;
(c) optionally copolymerizing a product of a process as described in paragraph (a) with a product of a process as described in paragraph (b);
   wherein each Ar is independently selected from one of the following moieties (i) to (iv) which is bonded by one or more of its phenyl moieties (preferably in its 4,4′-positions) to adjacent moieties

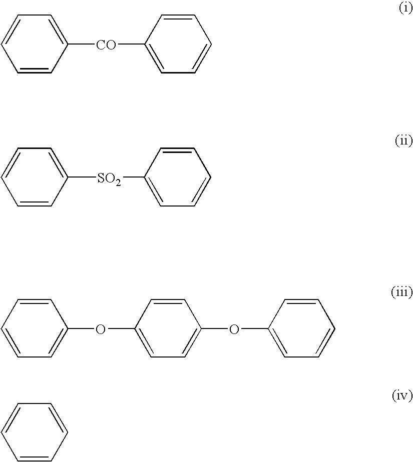

wherein each m, n, w, r, s, z, t and v is independently zero or a positive integer;
wherein each G is independently selected from an oxygen or sulphur atom, a direct link or a —O-Ph-O— moiety where Ph represents a phenyl moiety; and
wherein each E is independently selected from an oxygen or sulphur atom or a direct link.

Unless otherwise stated in this specification, a phenyl moiety preferably has 1,4′- or 1,3′-, especially 1,4′, linkages to moieties to which it is bonded.

Unless otherwise stated in this specification a phenyl moiety is preferably unsubstituted.

Preferred Ar moieties include moieties (i), (iii) and (iv).

Each m, n, w, r, s, z, t and v is preferably independently zero or 1.

The process may be used to produce a polymeric material as described below.

Said polymeric material may be a homopolymer having a repeat unit of general formula

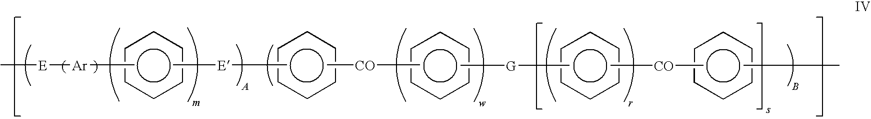

or a random or block copolymer of at least two different units of IV, wherein A and B independently represent 0 or 1 and E, G, Ar, m, r, s and w are as described in any statement herein and E′ may be independently selected from any moiety described for E.

As an alternative to a polymeric material comprising unit(s) IV discussed above, said polymeric material may be a homopolymer having a repeat unit of general formula

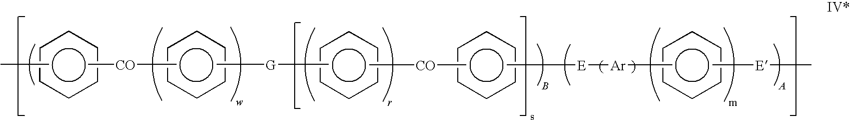

or a random or block copolymer of at least two different units of IV* wherein A and B, independently represent 0 or 1 and E, E′, G, Ar, m, r, s and w are as described in any statement herein.

Preferably, m is in the range 0-3, more preferably 0-2, especially 0-1. Preferably, r is in the range 0-3, more preferably 0-2, especially 0-1. Preferably, s is 0 or 1. Preferably, w is 0 or 1.

Preferably, said polymeric material is a homopolymer having a repeat unit of general formula IV.

Said polymeric material preferably comprises (e.g. at least 80 wt %, preferably at least 90 wt %, especially at least 95 wt % of said polymeric material comprises), more preferably consists essentially of, a repeat unit of formula

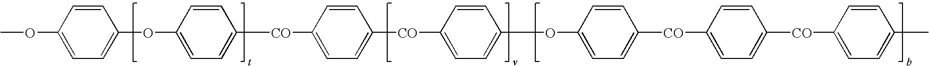

where t, v and b independently represent 0 or 1. Preferred polymeric materials have a said repeat unit wherein either t=1 or v=0 with in each case b=0; t=0, v=0 and b=0; t=0, v=1 and b=0; t=1, v=1, b=0; and t=0, v=0, s=1. More preferred have t=1 and v=0; or t=0 and v=0. The most preferred has t=1 and v=0.

In preferred embodiments, said polymeric material is selected from polyetheretherketone, polyetherketone, polyetherketoneketone, polyetheretherketoneketone and polyetherketoneetherketoneketone. In a more preferred embodiment, said polymeric material is selected from polyetherketone and polyetheretherketone. In an especially preferred embodiment, said polymeric material is polyetheretherketone.

The process described in (a) may be an electrophilic or a nucleophilic process.

In a first embodiment of the process described in (a) wherein Y¹ represents a hydrogen atom and Y² represents a group —COOH, the process may be electrophilic. The process is preferably carried out in the presence of a condensing agent which may be a methane sulphonic acid, for example methane sulphonic anhydride. A solvent is suitably present and this may be a methane sulphonic acid. In said first embodiment, preferably in said compound of formula V, Y¹ represents a hydrogen atom, Y² represents a group —COOH, Ar represents a moiety of formula (iii) and m represents 0, Said process may be as described in EP1263836 or EP1170318.

In a second embodiment of the process described in (a) preferably one of Y¹ and Y² represents a fluorine atom and the other represents an hydroxyl group. Such a monomer may be polycondensed in a nucleophilic process. Examples of monomers include 4-fluoro-4′-hydroxybenzophenone, 4-hydroxy-4′-(4-fluorobenzoyl)benzophenone; 4-hydroxy-4′-(4-fluorobenzoyl)biphenyl; and 4-hydroxy-4′-(4-fluorobenzoyl)diphenylether.

The process described in (b) is preferably nucleophilic Preferably, Y³ and Y⁴ each represent an hydroxy group. Preferably, X¹ and X² each represent a halogen atom, suitably the same halogen atom.

Where the process described in paragraph (b) is carried out, suitably, “a*” represents the mole % of compound VI used in the process; “b*” represents the mole % of compound VII used in the process; and “c*” represents the mole % of compound VIII used in the process.

Preferably, a* is in the range 45-55, especially in the range 48-52. Preferably, the sum of b* and c* is in the range 45-55, especially in the range 48-52. Preferably, the sum of a*, b* and c* is 100.

Preferably c* is 0. The polycondensation preferably comprises polycondensation of one monomer of formula VI and one monomer of formula VII and the sum of a* and b* is about 100.

The ratio of the number of moles of compounds(s) of formula VI to compound(s) of formula VII contacted in the method is preferably in the range 1 to 1.5, especially in the range 1 to 1.1. Preferably, only one compound of formula VI is used in the method.

Where the process described in paragraph (b) is carried out, preferably, one of either the total mole % of halogen atoms or groups -EH in compounds VI, VII and VIII is greater, for example by up to 10%, especially up to 5%, than the total mole % of the other one of either the total mole % of halogen atoms or groups -EH in compounds VI, VII and VIII. Where the mole % of halogen atoms is greater, the polymer may have halogen end groups and be more stable than when the mole % of groups -EH is greater in which case the polymer will have -EH end groups.

The molecular weight of the polymer can also be controlled by using an excess of halogen or hydroxy reactants. The excess may typically be in the range 0.1 to 5.0 mole %. The polymerisation reaction may be terminated by addition of one or more monofunctional reactants as end-cappers.

A preferred process described in (b) comprises polycondensing a compound of general formula VII wherein X¹ and X² represent fluorine atoms, w represents 1, G represents a direct link and s represents 0, with a compound of general formula VI wherein Y³ and Y⁴ represent —OH groups, Ar represents moiety (iv) and m represents 0 or with a compound of formula VI wherein Y³ and Y⁴ represent —OH groups, Ar represents moiety (i) and m represents 0. Another preferred process described in (b) comprises polycondensing a compound of general formula VII wherein X¹ and X² represent fluorine atoms, w represents 0, G represents a direct link, r represents 1 and s represents 1 with a compound of formula VI wherein Y³ and Y⁴ represents —OH groups, Ar represents a moiety (i) and m represents 0.

The monomer with said purity as described is preferably of general formula VII. X¹ and X² in said compound preferably represent fluorine atoms. Said monomer is preferably of formula VII wherein X¹ and X² represent fluorine atoms, w represents 1, G represents a direct link and s represents O,

Said process of the first aspect is preferably carried out in the presence of a solvent. The solvent may be of formula

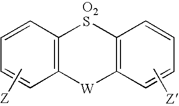

where W is a direct link, an oxygen atom or two hydrogen atoms (one attached to each benzene ring) and Z and Z′, which may be the same or different, are hydrogen atoms or phenyl groups. Examples of such aromatic sulphones include diphenylsulphone, dibenzothiophen dioxide, phenoxathiin dioxide and 4-phenylsulphonyl biphenyl. Diphenylsulphone is a preferred solvent.

The polymeric material prepared preferably consists essentially of moieties derived from the specified monomers (V), (VI), (VII) and (VIII).

A said polymer prepared preferably consists essentially of moieties derived from a monomer of formula V; or from a monomer of formula VI polycondensed with a monomer of formula VII. Preferably, said polymer does not include any moiety derived from a monomer of formula VIII.

In said compounds of formulae V, VI, VII and VIII each phenyl moiety is preferably 1,4-substituted.

The process described in paragraph(c) is preferably not used.

Preferred processes of the first aspect may be selected from:
(d) polycondensation of the following phenoxy benzoic acid with itself

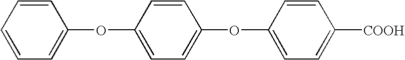

suitably to prepare a polymer which comprises, preferably consists essentially of, a polymer of formula X as herein defined, wherein p represents 1; and
(e) polycondensation of 4,4′-difluorobenzophenone with either hydroquinone or 4,4′-dihydroxybenzophenone.

Preferably, substantially the entirety of the repeat units are derived from the monomers referred to in (d) and (e).

In a preferred embodiment, the process comprises a polycondensation referred to in paragraph (e), suitably to prepare a polymer which comprises (e.g. at least 80 wt %, preferably at least 90 wt %, especially at least 95 wt % of said polymeric material comprises), preferably consists essentially of, a repeat unit of formula

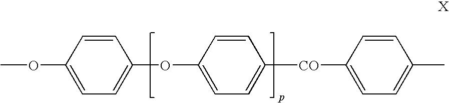

wherein p represents 0 or 1. In an especially preferred embodiment, p represents 1.

The MV of said polymeric material may be at least 0.06 kNsm⁻², more preferably is at least 0.08 kNsm⁻² and, especially, is at least 0.085 kNsm². The MV may be less than 4.0 kNsm⁻², is suitably less than 2.0 kNsm⁻², is preferably less than 1.0 kNsm², is more preferably less than 0.75 kNsm² and, especially, is less than 0.5 kNsm². Suitably the MV is in the range 0.08 kNsm² to 1.0 kNsm², preferably in the range 0.085 kNsm² to 0.5 kNsm².

Said polymeric material may have a tensile strength, measured in accordance with ASTM D638 of at least 100 MPa. The tensile strength is preferably greater than 105 MPa. It may be in the range 100-120 MPa, more preferably in the range 105-110 MPa.

Said polymeric material may have a flexural strength, measured in accordance with ASTM D790 of at least 145 MPa, preferably at least 150 MPa, more preferably at least 155 MPa. The flexural strength is preferably in the range 145-180 MPa, more preferably in the range 150-170 MPa, especially in the range 155-160 MPa.

Said polymeric material may have a flexural modulus, measured in accordance with ASTM D790, of at least 3.5 GPa, preferably at least 4 GPa. The flexural modulus is preferably in the range 3.5-4.5 GPa, more preferably in the range 3.8-4.4 GPa.

The glass transition temperature (T_{g}) of said polymeric material may be at least 140° C., suitably at least 143° C. In a preferred embodiment, the glass transition temperature is in the range 140° C. to 145° C.

The main peak of the melting endotherm (Tm) for said polymeric material (if crystalline) may be at least 300° C.

Said polymeric material is preferably semi-crystalline. The level and extent of crystallinity in a polymer is preferably measured by wide angle X-ray diffraction (also referred to as Wide Angle X-ray Scattering or WAXS), for example as described by Blundell and Osborn (Polymer 24, 953, 1983). Alternatively, crystallinity may be assessed by Differential Scanning Calorimetry (DSC).

The level of crystallinity in said polymeric material may be at least 1%, suitably at least 3%, preferably at least 5% and more preferably at least 10%. In especially preferred embodiments, the crystallinity may be greater than 30%, more preferably greater than 40%, especially greater than 45%.

Compounds of general formula V, VI, VII and VIII are commercially available (eg from Aldrich U.K.) and/or may be prepared by standard techniques, generally involving Friedel-Crafts reactions, followed by appropriate derivatisation of functional groups.

According to a second aspect of the invention, there is provided a polymeric material made in a process according to the first aspect.

According to a third aspect of the invention, there is provided a polymeric material having a repeat unit of formula

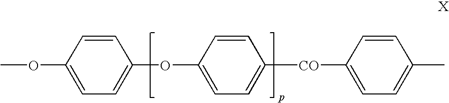

where p represents 0 or 1, said polymeric material having a melt viscosity (MV) measured in kNsm⁻² and a Melt Flow Index (MFI), wherein:

(a) when p represents 1, the actual log₁₀ MFI of said polymeric material is greater than the Expected Value for the log₁₀ MFI calculated using the formula:

Expected Value (EV)=−3.2218x+2.3327 wherein x represents the MV in kNsm⁻² of said polymeric material; or

(b) when p represents 0, the actual log₁₀ MFI of said polymeric material is greater than the Expected Value for the log₁₀ MFI calculated using the formula:

Expected Value (EV)=−2.539y+2.4299 wherein y represents the MV in kNsm⁻² of said polymeric material.

MFI is a measure of the ease of flow of the melt of a thermoplastic polymer. It may be measured as described in Test 2 hereinafter.

Said polymeric material may comprise at least 80 wt %, preferably at least 90 wt %, especially at least 95 wt % of said repeat unit X.

Said polymeric material preferably consists essentially of a repeat unit of formula X where p=1 or where p=0—that is, the polymeric material is preferably polyetheretherketone or polyetherketone.

When p represents 1, the actual log₁₀ MFI of said polymeric material may be greater than the Expected Value for the log₁₀ MFI calculated using the formula:

Expected Value (EV)=m₁x+2.33 where x represents the MV in kNsm⁻² of said polymeric material and m₁ is greater than −3.00. Suitably, m₁ is greater than −2.8, preferably greater than −2.6, more preferably greater than −2.5, especially greater than −2.45. In a preferred embodiment, when p represents 1, the Expected Value is approximately given by the equation:

Expected Value (EV)=−2.4x+2.34 wherein x represents the MV in kNsm⁻² of said polymeric material.

When p represents 0, the actual log₁₀ MFI of said polymeric material may be greater than the Expected Value for the log₁₀ MFI calculated using the formula:

Expected Value (EV)=m₂y+2.43 where y represents the MV in kNsm⁻² of said polymeric material and m₂ is greater than −2.5. Suitably, m₂ is greater than −2.45, preferably greater than −2.40, more preferably greater than −2.35.

According to a fourth aspect of the invention, there is provided a composite material comprising a polymeric material as described according to the second or third aspects in combination with a filler means.

Said filler means may include a fibrous filler or a non-fibrous filler. Said filler means may include both a fibrous filler and a non-fibrous filler.

A said fibrous filler may be continuous or discontinuous. In preferred embodiments a said fibrous filler is discontinuous.

A said fibrous filler may be selected from inorganic fibrous materials, non-melting and high-melting organic fibrous materials, such as aramid fibres, and carbon fibre.

A said fibrous filler may be selected from glass fiber, carbon fibre, asbestos fiber, silica fiber, alumina fiber, zirconia fiber, boron nitride fiber, silicon nitride fiber, boron fiber, fluorocarbon resin fibre and potassium titanate fiber. Preferred fibrous fillers are glass fibre and carbon fibre.

A fibrous filler may comprise nanofibres.

A said non-fibrous filler may be selected from mica, silica, talc, alumina, kaolin, calcium sulfate, calcium carbonate, titanium oxide, ferrite, clay, glass powder, zinc oxide, nickel carbonate, iron oxide, quartz powder, magnesium carbonate, fluorocarbon resin, graphite, carbon powder, nanotubes and barium sulfate. Fillers may be in conventional sizes or may comprise nano materials. The non-fibrous fillers may be introduced in the form of powder or flaky particles.

Said composite material could be prepared as described in PCT/GB2003/001872, the contents of which are incorporated herein by reference. Preferably, in the method, said polymeric material and said filler means are mixed at an elevated temperature, suitably at a temperature at or above the melting temperature of said polymeric material. Thus, suitably, said polymeric material and filler means are mixed whilst the polymeric material is molten. Said elevated temperature is suitably below the decomposition temperature of the polymeric material. Said elevated temperature is preferably at or above the main peak of the melting endotherm(Tm) for said polymeric material. Said elevated temperature is preferably at least 300° C. and more preferably is at least 350° C. Advantageously, the molten polymeric material can readily wet the filler and/or penetrate consolidated fillers, such as fibrous mats or woven fabrics, so the composite material prepared comprises the polymeric material and filler means which is substantially uniformly dispersed throughout the polymeric material. Advantageously, due to the higher MFI for a given MV, mixing, wetting and/or penetration may be easier compared to polymeric materials not made by the process in the first aspect.

The composite material may be prepared in a substantially continuous process. In this case polymeric material and filler means may be constantly fed to a location wherein they are mixed and heated. An example of such a continuous process is extrusion. Another example (which may be particularly relevant wherein the filler means comprises a fibrous filler) involves causing a continuous filamentous mass to move through a melt comprising said polymeric material. The continuous filamentous mass may comprise a continuous length of fibrous filler or, more preferably, a plurality of continuous filaments which have been consolidated at least to some extent. The continuous fibrous mass may comprise a tow, roving, braid, woven fabric or unwoven fabric. The filaments which make up the fibrous mass may be arranged substantially uniformly or randomly within the mass.

Alternatively, the composite material may be prepared in a discontinuous process. In this case, a predetermined amount of said polymeric material and a predetermined amount of said filler means may be selected and contacted and a composite material prepared by causing the polymeric material to melt and causing the polymeric material and filler means to mix to form a substantially uniform composite material.

The composite material may be formed into a particulate form for example into pellets or granules. Pellets or granules may have a maximum dimension of less than 10 mm, preferably less than 75 mm, more preferably less than 50 mm.

Preferably, said filler means comprises one or more fillers selected from glass fibre, carbon fibre, carbon black and a fluorocarbon resin. More preferably, said filler means comprises glass fibre or carbon, especially discontinuous, for example chopped, glass fibre or carbon fibre. Preferred discontinuous fibres have an average length before contact with the polymeric material, of less than 10 mm, preferably less than 7 mm. The average length may be greater than 1 mm, preferably greater than 2 mm. Preferably, a fibrous filler means consists essentially of fibers having a length, before contact with the polymeric material, of less than 10 mm.

Advantageously, a polymeric material as described according to the second and third aspects may be extruded under a lower pressure (e.g. in melt filtration and in other processes) compared to polymeric materials not made by the process of the first aspect and/or having the MV/MFI relationship described. Furthermore, films or fibres may be melt drawn to thinner gauges compared to other polymeric materials. Additionally, in dispersion and powder coating, the polymeric material may flow more easily upon melting which may facilitate formation of a coating on a component without defects such as pinholes. Thus, according to a fifth aspect of the invention, there is provided a method of making a component, the method comprising melt processing, for example extruding, injection moulding, roto-moulding, roto-lining or otherwise causing flow as in dispersion or powder coating, a polymeric material as described according to the second or third aspects.

Said method preferably involves selecting a precursor material from which to make the component wherein said precursor material comprises a said polymeric material and subjecting the precursor material to a temperature above its melting temperature, suitably in an extrusion or injection moulding apparatus, in a roto-moulding or lining apparatus or after deposition of a powder or dispersion upon a substrate. Suitably, said precursor material is heated to a temperature of greater than 300° C., preferably greater than 340° C. It is suitably heated to a temperature not exceeding 450° C.

Said precursor material may consist essentially of a said polymeric material described herein or a said composite material described herein.

Roto-lining involves lining a vessel or article with a polymeric material. A polymer powder is introduced into a two axis rotating fixture and caused to melt. By rotating the vessel/article and melting the polymer, the polymer adheres to internal regions of the vessel or article. In roto-moulding a similar procedure may be followed except that the vessel/article is split and the complete product (e.g. plastic container is de-moulded.

The method may comprise a melt process, for example an extrusion process, to make wire, film, fibre, stock shapes, plate, pipe, profiles, tubing or blown film.

In a sixth aspect, there is provided a melt processed component comprising a polymeric material as described and/or when made according to the fourth aspect.

The method of the fifth aspect may be used to make components having relatively thin walls. Thus, the invention, in a seventh aspect, relates to a method of making a component which has a wall which includes a region having a thickness of 3 mm or less, the method comprising:

(A) selecting a precursor material which comprises a polymeric material according to the second or third aspects;

AND

(B) treating said precursor material, thereby to form said component.

Preferably, the component includes a region having a thickness of 2 mm or less, more preferably 1 mm or less.

Said treatment described in (B) preferably involves melt processing said precursor material. Melt processing is preferably carried out by extrusion or injection moulding.

Suitably, said component includes a region having an area of at least 0.5 cm², preferably at least 1 cm², more preferably at least 5 cm² having a thickness as described. Thus, in one embodiment, said component may include a region of at least 0.5 cm² which has a thickness of 3 mm, preferably of 2 mm or less.

Any feature of any aspect of any invention or embodiment described herein may be combined with any feature of any aspect of any other invention or embodiment described herein mutatis mutandis.

Specific embodiments of the invention will now be described, by way of example, with reference to the accompanying figures in which

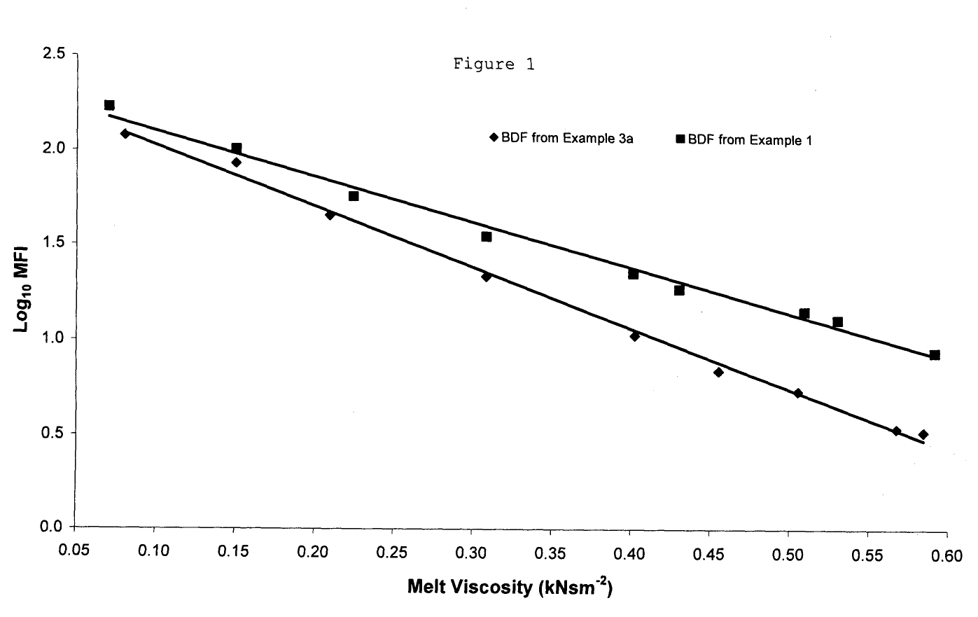

FIG. 1 is a plot of log₁₀MFI v. Melt Viscosity for polyetheretherketones made with different 4,4′-difluorobenzophenones; and

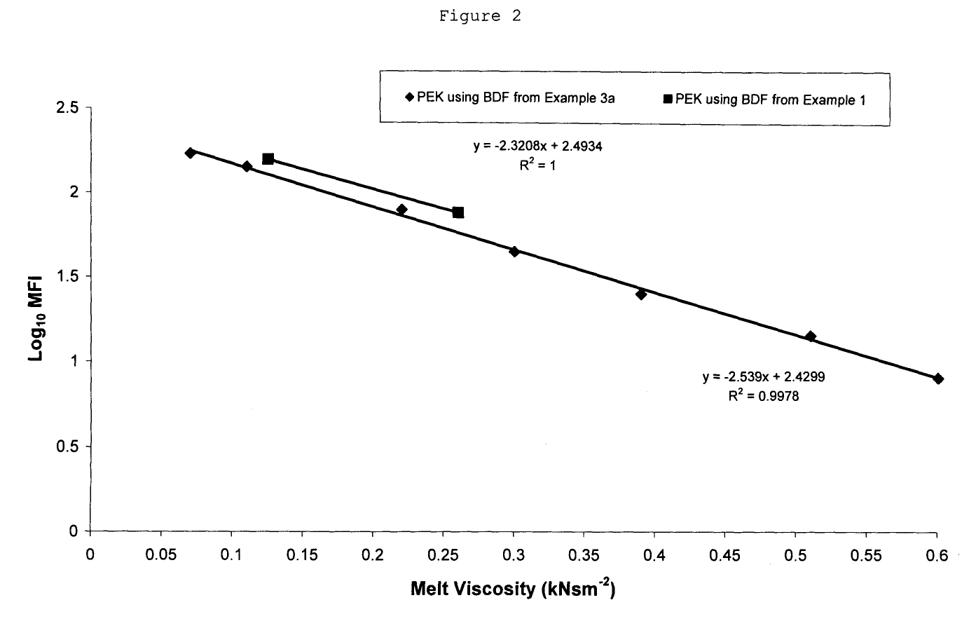

FIG. 2 is a plot of log₁₀MFI v. Melt Viscosity for polyetherketone.

Unless otherwise stated, all chemicals referred to hereinafter were used as received from Sigma-Aldrich Chemical Company, Dorset, U.K.

The following tests were used in the examples which follow.

### Test 1—Melt Viscosity of Polyaryletherketones

Melt Viscosity of the polyaryletherketone was measured using a ram extruder fitted with a tungsten carbide die, 0.5×3.175 mm. Approximately 5 grams of the polyaryletherketone was dried in an air circulating oven for 3 hours at 150° C. The extruder was allowed to equilibrate to 400° C. The dried polymer was loaded into the heated barrel of the extruder, a brass tip (12 mm long×9.92±0.01 mm diameter) placed on top of the polymer followed by the piston and the screw was manually turned until the proof ring of the pressure gauge just engages the piston to help remove any trapped air. The column of polymer was allowed to heat and melt over a period of at least 5 minutes. After the preheat stage the screw was set in motion so that the melted polymer was extruded through the die to form a thin fibre at a shear rate of 1000 s⁻¹, while recording the pressure (P) required to extrude the polymer. The Melt Viscosity is given by the formula

$$Melt Viscosity = \frac{P π {r}^{4}}{8 LSA} {kNsm}^{- 2}$$

where
   P=Pressure/kN m⁻²
   L=Length of die/m
   S=ram speed/m s⁻¹
   A=barrel cross-sectional area/m²
   r=Die radius/m
The relationship between shear rate and the other parameters is given by the equation:

$$Apparent wall shear rate = 1000 {s}^{- 1} = \frac{4 Q}{π {r}^{3}}$$

where Q=volumetric flow rate/m³ s⁻¹=SA

### Test 2−Melt Flow Index of Polyaryletherketones

The Melt Flow Index of the polyaryltherketone was measured on a CEAST Melt Flow Tester 6941.000. The dry polymer was placed in the barrel of the Melt Flow Tester apparatus and heated to a temperature specified in the appropriate Examples, this temperature being selected to fully melt the polymer. The polymer was then extruded under a constant shear stress by inserting a weighted piston (5 kg) into the barrel and extruding through a tungsten carbide die, 2.095 mmbore×8.000 mm. The MFI (Melt Flow Index) is the mass of polymer (in g) extruded in 10 minutes.

Test 3—Gas Chromatographic (Gc) Analysis of 4,4′-difluorobenzophenone

Gc analysis was performed on a Varian 3900 Gas Chromatograph, using a Varian GC column: CP Sil 8CB non-polar, 30 m, 0.25 mm, 1 μm DF (part no. CP8771) and the running conditions were:
Injector temperature 300° C.
Detector temperature 340° C.
Oven ramp 100° C. to 300° C. at 10° C./min hold 10 minutes (total run time 30 minutes)
Split ratio 50:1
Injection volume 1 μL

The sample is made up by dissolving 100 mg of 4,4′-difluorobenzophenone in 1 ml of dichloromethane.

The GC retention time for 4,4′-difluorobenzophenone is around 13.8 minutes.

The purity is quoted as a area %, calculated using a standard method.

### Test 4—Melting Point Range Determination

The melting point range is determined automatically by optical transmission measurement using a Büchi B-545. The first value is recorded at 1 percent transmission.

Settings:

| | |
|---|---|
| gradient: | 1° C./min |
| Set point: | 101° C. |
| mode: | pharmacopoe |
| detection: | 1 and 90 percent |

The melting point range is recorded as the difference between 90 and 1 percent of melting point determination.

### EXAMPLE 1

### Preparation of 4,4′-difluorobenzophenone (BDF) by Reacting Fluorobenzene and Carbon Tetrachloride (Based on the Process Described by L. V. Johnson, F Smith, M Stacey and J C Tatlow, J. Chem. Soc., 4710-4713 (919) 1952)

A 11 3-necked round-bottomed flask fitted with a mechanical stirrer, a thermometer, a dropping funnel containing fluorobenzene (192 g, 2 moles) and carbon tetrachloride (290 g), a thermometer and a reflux condenser was charged with carbon tetrachloride (250 g) and anhydrous aluminium trichloride (162 g, 1.2 moles). The fluorobenzene/carbon tetrachloride solution was added dropwise over a period of 1 hour to the aluminium trichloride suspension in carbon tetetrachloride maintained at 10° C. with stirring. The reaction mixture was then maintained at 15° C. for a further 16 hours. The reaction mixture was poured into ice-water, the organic layer was separated, washed with aqueous sodium bicarbonate solution, then with water.

The organic phase was charged to a 21 3-necked round-bottomed flask fitted with a mechanical stirrer, a thermometer and a reflux condenser containing a 50:50 mixture of ethanol/water (500 cm³). The mixture was heated to reflux temperature and held for 30 minutes, allowed to cool to room temperature and the crude solid product was recovered by filtration and dried at 70° C. under vacuum.

Dry crude product (100 g) was dissolved with stirring in hot industrial methylated spirits (400 cm³) and charcoal, filtered, water (100 cm³) was added, reheated to reflux dissolve the product and cooled. The product was filtered off, washed with 1:1 industrial methylated spirits/water then dried at 70° C. under vacuum. The product had melting point range of 107-108° C. determined using Test 4 and a purity of 99.9 area % 4,4′-difluorobenzophenone determined using Test 3

### EXAMPLE 2

### Preparation of 4,4′-difluorobenzophenone (BDF) by Reacting Fluorobenzene and 4-fluorobenzoylchloride

A 101 3-necked round-bottomed flask fitted with a mechanical stirrer, a thermometer, a dropping funnel containing 4-fluorobenzoyl chloride (1550 g, 9.78 moles) and a reflux condenser was charged with fluorobenzene (2048 g, 21.33 moles) and anhydrous aluminium trichloride (1460 g, 10.94 moles). The mixture was maintained at 20 to 30° C. with stirring and the 4-fluorobenzoylchloride was added dropwise over a period of 1 hour. When the addition was complete the temperature of the reaction mixture was increased to 80° C. over a period of 2 hours, allowed to cool to ambient temperature then carefully discharged into ice(4 kg)/water(2 kg). The mixture was recharged to a 201 1-necked round-bottomed flask fitted with distill head. The contents were heated to distill off the excess fluorobenzene until a still-head temperature of 100° C. was reached. The mixture was cooled to 20° C. and the crude 4,4′-difluorobenzophenone was filtered off, washed with water and dried at 70° C. under vacuum.

The crude product was recrystallised as described in Example 1. The product had a melting point range of 107-108° C. determined using Test 4 and a purity of 99.9 area % 4,4′-difluorobenzophenone determined using Test 3.

### EXAMPLE 3

### Preparation of 4,4′-difluorobenzophenone (BDF) by the Nitric Acid Oxidation of 4,4′-difluorodiphenylmethane

The process described in Example 2, EP 4710 A2 for the oxidation of 4,4′-difluorodiphenylmethane was followed except the scale was increased by a factor of 3.

### EXAMPLE 3a

Following the recrystallisation procedure described in Example 2 of EP 4710 A2, 4,4′-difluorobenzophneone(115 g) with a melting point range 106-107° C. and a purity of 99.6%, analysed using Test 3 was produced.

### EXAMPLE 3b

The product from Example 3a was recrystallised again using the same procedure giving 4,4′-difluorobenzophenone (95 g) with a melting point range 107-108° C. and a purity of 99.9% as analysed by gc.

### EXAMPLE 4a

### Preparation of Polyetheretherketone

A 250 ml flanged flask fitted with a ground glass Quickfit lid, stirrer/stirrer guide, nitrogen inlet and outlet was charged with 4,4′-difluorobenzophenone from Example 1 (22.48 g, 0.103 mole), hydroquinone (11.01 g, 0.1 mole) and diphenylsulphone (49 g) and purged with nitrogen for over 1 hour. The contents were then heated to between 140 and 150° C. to form an almost colourless solution. Dried sodium carbonate (10.61 g, 0.1 mole) and potassium carbonate (0.278 g, 0.002 mole) were added. The temperature was raised to 200° C. and held for 1 hour; raised to 250° C. and held for 1 hour; raised to 315° C. and maintained for 2 hours. The details of the Melt Viscosity and Melt Flow Index of the product measured using Tests 1 and 2 respectively are given in Table 1 below.

### EXAMPLES 4b-4t

### Preparation of Samples of Polyetheretherketone from Different Sources of 4,4′-difluorobenzophenone (BDF) and a Range of Melt Viscosities

The procedure described in Example 4a was repeated except the source of 4,4′-difluorobenzophenone was changed and the polymerisation time was varied to produce polyetheretherketone with a range of melt viscosities. The details of the Melt Viscosity and Melt Flow Index of the products are given in Table 1 below.

TABLE 1

| | | | | Melt Flow |
|---|---|---|---|---|
| | 4,4′- | Reaction | Melt | Index |
| | diflurobenzophenone | Time | Viscosity | 380° C. |
| Example | source | (mins) | (kNsm⁻²) | (g/10 min) |
| 4a | Example 1 | 115 | 0.07 | 169.3 |
| 4b | Example 1 | 120 | 0.15 | 102.0 |
| 4c | Example 1 | 140 | 0.22 | 57.4 |
| 4d | Example 1 | 165 | 0.31 | 35.3 |
| 4e | Example 1 | 180 | 0.40 | 22.6 |
| 4f | Example 1 | 180 | 0.43 | 18.6 |
| 4g | Example 1 | 190 | 0.51 | 14.2 |
| 4h | Example 1 | 190 | 0.53 | 12.9 |
| 4i | Example 1 | 195 | 0.59 | 8.7 |
| 4j | Example 2 | 160 | 0.42 | 19.4 |
| 4k | Example 3a | 105 | 0.08 | 120.0 |
| 4l | Example 3a | 115 | 0.15 | 85.6 |
| 4m | Example 3a | 145 | 0.21 | 45.3 |
| 4n | Example 3a | 155 | 0.31 | 21.6 |
| 4o | Example 3a | 160 | 0.40 | 10.6 |
| 4p | Example 3a | 175 | 0.46 | 6.9 |
| 4q | Example 3a | 180 | 0.51 | 5.4 |
| 4r | Example 3a | 190 | 0.57 | 3.4 |
| 4s | Example 3a | 190 | 0.58 | 3.2 |
| 4t | Example 3b | 180 | 0.44 | 18.4 |

The Melt Viscosity and MFI data for Examples 4a to 4i and 4k to 4s are presented graphically in FIG. 1 from which it may be calculated

Log₁₀ MFI (Example 3a based polyetheretherketone)=2.35−3.22*Melt Viscosity (Example 3a based polyetheretherketone); and

Log₁₀ MFI (Example 1 based polyetheretherketone)=2.34−2.4*Melt Viscosity (Example 1 based polyetheretherketone)

### EXAMPLE 5a

### Preparation of Polyetherketone

A 250 ml flanged flask fitted with a ground glass Quickfit lid, stirrer/stirrer guide, nitrogen inlet and outlet was charged with 4,4′-difluorobenzophenone from Example 1 (33.49 g, 0.153 mole), 4,4′-dihydroxybenzophenone (32.13 g, 0.150 mole) and diphenylsulphone (124.5 g) and purged with nitrogen for over 1 hour. The contents were then heated to 160° C. to form an almost colourless solution. Dried sodium carbonate (16.59 g, 0.156 mole) was added. The temperature was raised to 340° C. at 1° C./min and held for 2 hours.

The reaction mixture was allowed to cool, milled and washed with acetone and water. The resulting polymer was dried in an air oven at 120° C. producing a powder. The details of the colour, Melt Viscosity and Melt Flow Index of the product are given in Table 2 below.

### EXAMPLE 5b-j

### Preparation of a Sample of Polyetherketone from a Different Source of 4,4′-difluorobenzophneone

The procedure described in Example 5a was repeated except the source of 4,4′-difluorobenzophenone was changed and the polymerisation time was varied to produce polyetheretherketone with a range of melt viscosities. Details are provided in Table 2.

TABLE 2

| | | | | Melt Flow |
|---|---|---|---|---|
| | 4,4′- | Reaction | Melt | Index |
| | diflurobenzophenone | Time | Viscosity | 400° C. |
| Example | source | (mins) | (kNsm⁻²) | (g/10 min) |
| 5a | Example 1 | 120 | 0.125 | 160 |
| 5b | Example 1 | 125 | 0.26 | 67 |
| 5c | Example 3a | 110 | 0.07 | 171 |
| 5d | Example 3a | 120 | 0.11 | 146 |
| 5e | Example 3a | 125 | 0.22 | 81 |
| 5f | Example 3a | 135 | 0.3 | 46 |
| 5g | Example 3a | 145 | 0.39 | 26 |
| 5h | Example 3a | 160 | 0.44 | 20.8 |
| 5i | Example 3a | 165 | 0.51 | 14 |
| 5j | Example 3a | 170 | 0.6 | 18 |

The Melt Viscosity and MFI data for Examples 5a to 5j are represents graphically in FIG. 2 from which it may be calculated:

Log₁₀ MFI (Example 3a-based polyketone)=2.42−2.539*Melt Viscosity (Example 3a-based Polyketone)

The relatively high MFI of polymeric materials described may have significant advantages in industrial applications over lower MFI materials, for the same MV. For example, due to the relative ease of flow the relatively high MFI materials may be used in composite materials with higher levels of fillers. Furthermore, it is found that the higher MFI materials may be extruded at lower pressure (in one example a high MFI material could be extruded at 75 bar compared to an equivalent MV material having low MFI which had to be extruded at 110 bar). This may allow films and fibres to be drawn to thinner gauges. Furthermore, thinner walled components may be made with higher MFI materials. Additionally, the higher MFI materials may be used in dispersion or powder coatings since the polymeric materials forming the coating can flow more easily to produce a continuous coating layer.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A polymeric material having a repeat unit of formula 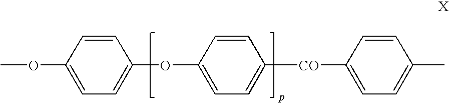
where p represents 0 or 1, said polymeric material having a melt viscosity (MV) measured in kNsm⁻² and a Melt Flow Index (MFI), wherein:
(a) when p represents 1, the actual log₁₀ MFI of said polymeric material is greater than the Expected Value for the log₁₀ MFI calculated using the formula:
Expected Value (EV)=−3.2218x+2.3327 wherein x represents the MV in kNsm⁻² of said polymeric material; or
(b) when p represents 0, the actual log₁₀ MFI of said polymeric material is greater than the Expected Value for the log₁₀ MFI calculated using the formula:
Expected Value (EV)=−2.539y+2.4299 wherein y represents the MV in kNsm⁻² of said polymeric material.

2. A polymeric material according to claim 1, wherein said polymeric material consists essentially of a repeat unit of formula X where p=1 or where p=0.

3. A polymeric material according to claim 2, wherein:
when p represents 1, the actual log₁₀ MFI of said polymeric material is greater than the Expected Value for the log₁₀ MFI calculated using the formula:
Expected Value (EV)=m₁x+2.33 where x represents the MV in kNsm⁻² of said polymeric material and m₁ is greater than −3.00; or
when p represents 0, the actual log₁₀ MFI of said polymeric material is greater than the Expected Value for the log₁₀ MFI calculated using the formula:
Expected Value (EV)=m₂y+2.43 where y represents the MV in kNsm⁻² of said polymeric material and m₂ is greater than −2.5.

4. A polymeric material according to claim 3, wherein m₁ is greater than −2.8.

5. A polymeric material according to claim 4, wherein m₂ is greater than −2.45.

6. A polymeric material according to claim 5, wherein m₁ is greater than −2.45.

7. A polymeric material according to claim 6, wherein m₂ is greater than −2.35.

8. A polymeric material according to claim 7, wherein the MV of said polymeric material is at least 0.06 kNsm⁻² and is less than 4.0 kNsm⁻².

9. A composite material comprising a polymeric material as described according to claim 1 in combination with a filler means.

10. A method of making a component, the method comprising melt processing a polymeric material according to claim 1.

11. A melt processed component comprising a polymeric material according to claim 1.

12. A method of making a component which has a wall which includes a region having a thickness of 3 mm or less, the method comprising:
(A) selecting a precursor material which comprises a polymeric material according to any of claim 1;
AND
(B) treating said precursor material, thereby to form said component.

13. A process for the preparation of a polymeric material which includes phenyl moieties, ketone moieties and ether moieties in the polymeric backbone of said polymeric material, said process comprising selecting at least one monomer having a moiety of formula 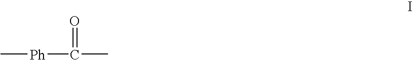
wherein Ph represents a phenyl moiety and wherein said at least one monomer has a purity of at least 99.7 area %.

14. A process according to claim 13, wherein said at least one monomer has a purity of at least 99.85 area %.

15. A process according to claim 13, wherein said at least one monomer has a purity of at least 99.9 area %.

16. A process according to claim 13, wherein said at least one monomer includes at least two phenyl moieties which are unsubstituted, said two phenyl moieties being spaced apart by another atom or group selected from —O— and —CO—.

17. A process according to claim 13, wherein said at least one monomer comprises phenoxyphenoxybenzoic acid or a benzophenone.

18. A process according to claim 13, wherein said at least one monomer includes a terminal group selected from a halogen atom, an —OH— moiety and a —COOH— moiety.

19. A process according to claim 13, said process comprising:
(a) polycondensing a compound of general formula 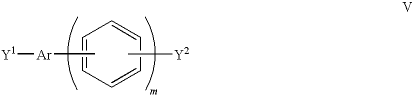
with itself wherein Y¹ represents a halogen atom or a group -EH and Y² represents a halogen atom or a group —COOH or EH, provided that Y¹ and Y² do not together represent hydrogen atoms;
(b) polycondensing a compound of general formula 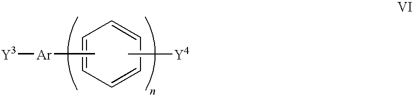
with a compound of formula 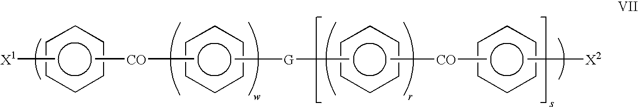
and/or with a compound of formula 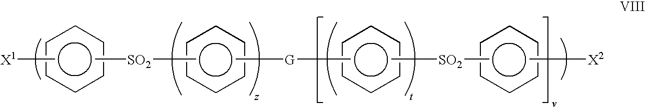
wherein Y³ represents a halogen atom or a group -EH and X¹ represents the other one of a halogen atom or group -EH and Y⁴ represents a halogen atom or a group -EH and X² represents the other one of a halogen atom or a group -EH;
(c) optionally copolymerizing a product of a process as described in paragraph (a) with a product of a process as described in paragraph (b);
wherein each Ar is independently selected from one of the following moieties (i) to (iv) which is bonded by one or more of its phenyl moieties (preferably in its 4,4′-positions) to adjacent moieties 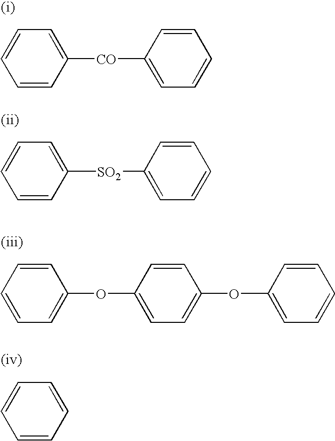
wherein each m, n, w, r, s, z, t and v is independently zero or a positive integer;
wherein each G is independently selected from an oxygen or sulphur atom, a direct link or a
—O-Ph-O— moiety where Ph represents a phenyl moiety; and
wherein each E is independently selected from an oxygen or sulphur atom or a direct link.

20. A process according to claim 13, wherein said polymeric material comprises a repeat unit of formula 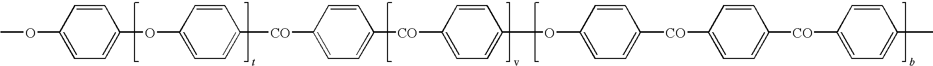
where t, v and b independently represent 0 or 1.

21. A process according to claim 13, wherein said polymeric material is selected from polyetheretherketone, polyetherketone, polyetherketoneketone, polyetheretherketoneketone and polyetherketoneetherketoneketone.

22. A process according to claim 1, wherein said polymeric material is polyetheretherketone.
